(19) United States
(12) Patent Application Publication
(10) Pub. No.: US 2014/0358822 A1
(43) Pub. Date: Dec. 4, 2014

(54) SYSTEMS AND METHODS FOR DETECTING PROPERTY CAPITAL GAINS

(71) Applicant: LexisNexis Risk Solutions FL Inc., Boca Raton, FL (US)

(72) Inventors: Scott M. Straub, Washington, DC (US); Andrew John Bucholz, Alexandria, VA (US); Dermot C. O'Mahony, Washington, DC (US); Alexandre Lvoff, Washington, DC (US); Lawrence Benson, Atkinson, NH (US)

(21) Appl. No.: 13/906,494

(22) Filed: May 31, 2013

(51) Int. Cl. G06Q 40/06; G06Q 50/26; G06Q 50/16

(52) U.S. Cl. CPC G06Q 40/06; G06Q 50/26; G06Q 50/16
USPC 705/36 R

(57) ABSTRACT

Certain embodiments of the disclosed technology may include systems and methods for detecting property capital gains. According to an example embodiment of the disclosed technology, a method is provided that includes receiving property transaction information comprising previous owner identification (ID) and property ID associated with a property. The method includes querying one or more databases with the property transaction information, receiving independent data in response to the querying, producing transformed data based at least in part on the independent data and the property transaction information, determining potential property capital gains for the property based at least in part on one or more of the property transaction information, the independent data, and the transformed data, and outputting data identifying the determined potential property capital gains associated with the property.

### CROSS-REFERENCE TO RELATED APPLICATIONS

This application is related to U.S. Pat. No. 7,403,942 to Bayliss, David et al. (hereinafter Bayliss I), filed Feb. 4, 2003, and to U.S. patent application Ser. No. 10/357,489 to Bayliss, David et al. (hereinafter Bayliss II), filed Feb. 4, 2003, the contents of which are hereby incorporated by reference as if fully set forth below.

### FIELD

The disclosed technology generally relates to detecting property capital gains, and in particular, to systems and methods for identifying unreported property capital gains.

### BACKGROUND

Federal, state and county governmental agencies often rely on individuals to self-report property transactions that have associated capital gains tax consequences. In many cases, the revenue owed to these agencies may remain uncollected for various reasons, including insufficient sharing of information between the agencies, lack of information, etc. For example, real-estate transaction information is recorded at the county level in a deed, and such information may or may not be sufficient to determine the length of ownership by the previous owner. Furthermore, if the transaction information recorded on the deed is not shared with the State Revenue Department, it may be difficult (or impossible) for the governmental agencies pinpoint people with unreported property capital gains.

### BRIEF SUMMARY

Some or all of the above needs may be addressed by certain embodiments of the disclosed technology. Certain embodiments of the disclosed technology may include systems and methods for detecting property capital gains.

According to an example embodiment of the disclosed technology, a computer-implemented method is provided for detecting property capital gains. The method includes receiving property transaction information. In certain example embodiments, the property transaction information may include information identifying the seller, the property address, and the transaction date and/or year. In certain example embodiments, the property transaction information may include additional information, including, but not limited to the seller's social security number. The method further includes querying one or more databases with the property transaction information; receiving independent data in response to the querying; producing transformed data based at least in part on the independent data and the property transaction information; determining potential property capital gains for the property based at least in part on one or more of the property transaction information, the independent data, and the transformed data; and outputting data identifying the determined potential property capital gains associated with the property.

According to another example embodiment, a system is provided. The system includes at least one memory for storing data and computer-executable instructions; and at least one processor configured to access the at least one memory and is further configured to execute the computer-executable instructions to receive property transaction information including previous owner identification (ID) and property ID associated with a property; query one or more databases with the property transaction information; receive independent data in response to the querying; produce transformed data based at least in part on the independent data and the property transaction information; determine potential property capital gains for the property based at least in part on one or more of the property transaction information, the independent data, and the transformed data; and output data identifying the determined potential property capital gains associated with the property.

Example embodiments of the disclosed technology can include one or more computer readable media comprising computer-executable instructions that, when executed by one or more processors, configure the one or more processors to perform a method. The method includes receiving property transaction information comprising previous owner identification (ID) and property ID associated with a property. The method further includes querying one or more databases with the property transaction information; receiving independent data in response to the querying; producing transformed data based at least in part on the independent data and the property transaction information; determining potential property capital gains for the property based at least in part on one or more of the property transaction information, the independent data, and the transformed data; and outputting data identifying the determined potential property capital gains associated with the property.

Other embodiments, features, and aspects of the disclosed technology are described in detail herein and are considered a part of the claimed disclosed technology. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1A is a block diagram of an illustrative property transfer scenario 100, according to example embodiments of the disclosed technology.

FIG. 1B is a block diagram of another illustrative property transfer scenario, according to example embodiments of the disclosed technology.

FIG. 2 is a block diagram of an illustrative property capital gains detection process 200 according to an example embodiment of the disclosed technology.

FIG. 3 is a block diagram of an illustrative property capital gains detection computing system 300 according to an example embodiment of the disclosed technology.

FIG. 4 is a flow diagram of a method 400 according to an example embodiment of the disclosed technology.

### DETAILED DESCRIPTION

In the following description, numerous specific details are set forth. However, it is to be understood that embodiments of the disclosed technology may be practiced without these specific details. In other instances, well-known methods, structures and techniques have not been shown in detail in order not to obscure an understanding of this description. References to “one embodiment,” “an embodiment,” “example embodiment,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Certain embodiments of the disclosed technology may enable detection of capital gains associated with an entity (such as an individual, a business, a corporation, etc.) in relation to a particular property (for example, land, real-estate, house, rental property, business property, etc.). Example embodiments of the disclosed technology may utilize information supplied by new and/or previous owners of the property together with information obtained from other sources, such as public or private databases, to determine possible capital gains.

In accordance with certain example embodiments of the disclosed technology, various forms of property capital gains (having possible tax consequences) may be determined or detected based on available and/or derived data. Property capital gains may fall into one of two categories: short-term, and long-term capital gains. A number of factors may be considered for proper characterization into these categories. For example, if a property is owned for less than 12 months, or if home associated with the property is occupied for less than two of the previous five years by the owner, then any gains in value upon a sale of the property (for example, the sale price less the basis value of the property) may be calculated and categorized as short-term capital gains, resulting in a tax owed by the seller at their regular income tax rate. Otherwise, the gains may be characterized as long-term capital gains, and assessed a tax based on the long-term capital gains rate, which may be a lower rate compared with the short-term capital gains rate. In other words, according to certain embodiments, short-term capital gains may apply for properties held less than 12 months, and long-term capital gains taxes may apply to a property that is owned for more than 12 months. An exclusion of the gain may be applied if the owner occupied the home in two of the previous five years.

As indicated in the background section above, governmental agencies that collect tax revenue often rely on self-reporting of property transactions that may result in tax consequences. For example, an individual's state and/or federal income tax return may include information pertaining to the sale of a residence. However, if this information is omitted (inadvertently or intentionally), the tax revenues owed and associated with the sale of the property may go uncollected.

According to certain example embodiments of the disclosed technology, information recorded at the county level, and associated with the sale of a property (for example, from property deeds, titles, etc.) may be utilized in conjunction with other information (such as state tax return information, for example) to determine dates, durations, gains etc., to detect unreported property capital gains. In certain example embodiments, information related to a property transaction may be analyzed to determine if the previous owner still lives in-state, had more than one residence, filed a tax return in the state in which the property was sold, is deceased, etc. Such information may be utilized, according to example embodiments, to accurately characterize, categorize, and/or determine a potential amount of tax revenue that may be collected. In certain example embodiments of the disclosed technology, this information determined may be presented in a report. For example, the report may include rankings of possible unreported capital gain amounts to assist tax-collecting agencies in prioritizing their efforts to collect unpaid taxes.

In accordance certain example embodiments of the disclosed technology, basic property capital gains information may be derived based on the various sources of information, including, but not limited to: (a) the identity of the property owner; (b) the duration of ownership; and (c) the change in value of the property. According to example embodiment, this information may provide the necessary metrics for calculating property capital gains, and/or for determining whether or not further information is needed, for example, to meet certain confidence criteria.

Example embodiments of the disclosed technology may utilize techniques described in the Bayliss 1 and the Bayliss II patent literature (incorporated by reference) to transform data associated with an entity and/or a property. For example, certain embodiments may include querying one or more databases with the property transaction information and receiving data in response to the querying. In accordance with an example embodiment, the techniques described in Bayliss 1 and Bayliss II may transform the received data, for example, to eliminate duplicate records, correct spellings, find matching records, filter data, etc., and/or determine potential property capital gains based at least in part on one or more of the property transaction information, the received data, and the transformed data.

According to an example implementation, regional tax code regulations may further be utilized to detect and classify the property capital gains. For example, Table 1 below lists example short- and long-term capital gains from state-to-state (as of 2007), illustrating the variability from region-to-region. Table 2 below lists the federal capital gains tax as of December, 2012. In accordance with an example embodiment of the disclosed technology, example tax information, such as that shown below in Table 1 and Table 2 may be utilized to further determine potential property capital gains.

TABLE 1
State Capital Gains Tax Rates for the United States
(2007)

| | Short- | Long |
|---|---|---|
| | Term | Term |
| | Capital | Capital |
| | Gains | Gains |
| State | % | % |
| Alabama | 5 | 5 |
| Alaska | 0 | 0 |
| Arizona | 5.04 | 4.54 |
| Arkansas | 7 | 4.9 |
| California | 9.3 | 10.3 |
| Colorado | 4.63 | 4.63 |
| Connecticut | 4.5 | 6.7 |
| Delaware | 5.95 | 6.75 |
| DC | 9 | 8.95 |
| Florida | 0 | 0 |
| Georgia | 6 | 6 |
| Hawaii | 8.5 | 11.0 |
| Idaho | 8.2 | 7.8 |
| Illinois | 3 | 5 |
| Indiana | 3.4 | 3.4 |
| Iowa | 8.98 | 8.98 |
| Kansas | 6.45 | 6.45 |
| Kentucky | 6 | 6 |
| Louisiana | 6 | 6 |
| Maine | 8.5 | 8.5 |
| Maryland | 4.8 | 5.5 |
| Massachusetts | 12 | 5.6 |
| Michigan | 4.2 | 4.35 |
| Minnesota | 7.85 | 7.85 |
| Mississippi | 5 | 5 |
| Missouri | 6 | 6 |
| Montana | 11 | 4.9 |
| Nebraska | 6.68 | 6.84 |
| Nevada | 0 | 0 |
| New | 0 | 0 |
| Hampshire | | |
| New Jersey | 6.37 | 8.97 |
| New Mexico | 8.2 | 2.45 |
| New York | 6.85 | 8.82 |
| N. Carolina | 7.75 | 7.75 |
| North Dakota | 5.54 | 7.793 |
| Ohio | 6.98 | 5.925 |
| Oklahoma | 6.75 | 5.25 |
| Oregon | 9 | 9.9 |
| Pennsylvania | 3.07 | 3.07 |
| Rhode Island | 5.1 | 5.99 |
| S. Carolina | 7 | 3.92 |
| South Dakota | 0 | 0 |
| Tennessee | 0 | 0 |
| Texas | 0 | 0 |
| Utah | 7 | 5 |
| Vermont | 4.8 | 8.95 |
| Virginia | 5.75 | 5.75 |
| Washington | 0 | 0 |
| West Virginia | 6.5 | 6.5 |
| Wisconsin | 6.75 | 5.43 |
| Wyoming | 0 | 0 |

TABLE 2
Federal Capital Gains Tax Rates for Main Home
(2012)

| Holding Period | Federal Tax Rate |
|---|---|
| One year or less | Short-term capital gains = |
| | ordinary income tax rates up to 35% |
| More than one year | Long-term capital gains = |
| | 5% for taxpayers in the 10% and 15% tax |
| | brackets, up to 15% after exclusion amount |

Embodiments of the disclosed technology will be described more fully hereinafter with reference to the accompanying drawings, in which embodiments of the disclosed technology are shown. This disclosed technology may, however, be embodied in many different forms and should not be construed as limited to the embodiments set forth herein; rather, these embodiments are provided so that this disclosure will be thorough and complete, and will fully convey the scope of the disclosed technology to those skilled in the art.

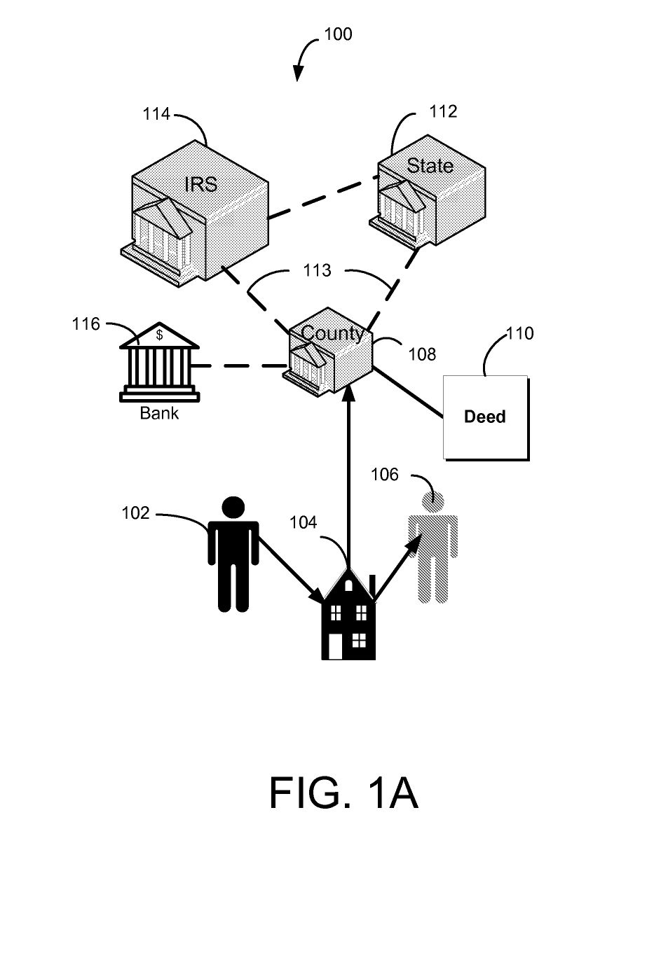

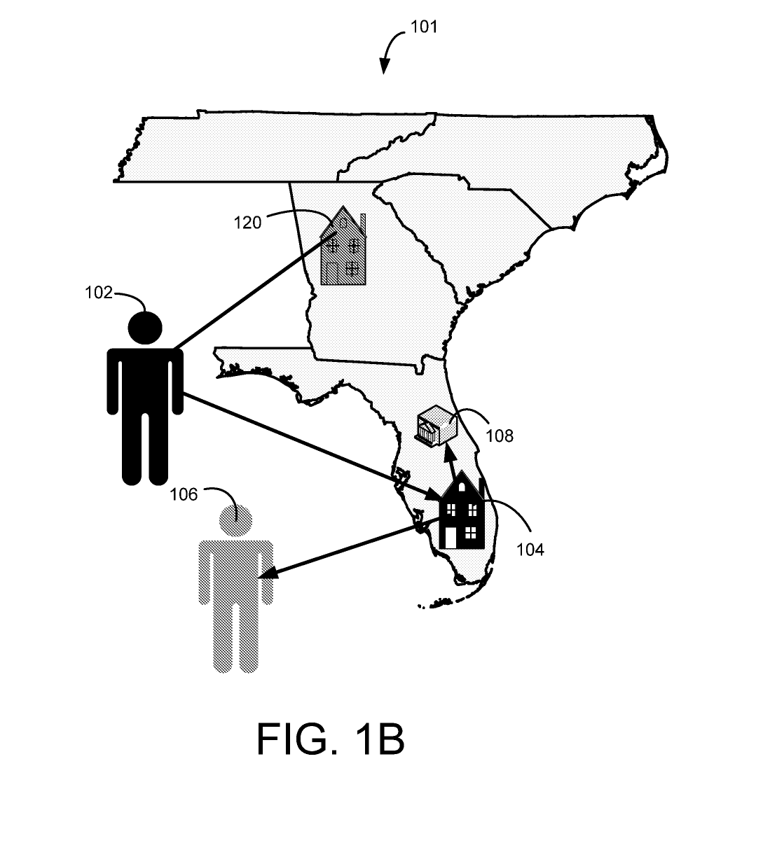

FIG. 1A shows a block diagram of illustrative property sale scenario, according to example embodiments of the disclosed technology. In this example embodiment, a property 104 may be sold by a previous owner 102 to a new owner 106. Upon the sale (or closing) of the property 104, the transaction information may be recorded by the county entity 108 in the form of a deed 110, or other legal document. Such transfer information may identify the parties involved, a property ID, a sale price, the date of the sale or closing, and other information such as a description of the property, a title search result, etc.

In many of the real-life property transaction scenarios similar to the one depicted in FIG. 1A, the transaction information recorded with the county entity 108 may or may not be shared 113 with the State Revenue Department 112 or the Internal Revenue Service (IRS) 114. In some cases, the bank providing financing 116 may have access to the information recorded on the deed 110, but the IRS 114 and the State Revenue Department 112 may rely upon the previous owner 102 to report the particulars of the property transaction on their tax return forms. Example embodiments of the disclosed technology may identify transactions that have taken place and compare the information with tax return information to determine incidents of unreported capital gains.

FIG. 1B depicts another (slightly more complicated) scenario in which the previous owner 102 lives in one state (for example, Georgia) but sells a first property 104 in another state (for example, Florida) to a new owner 106. As depicted in FIG. 1A, the transaction information may be recorded by the county entity 108 that has jurisdiction over the first property 104 in Florida. The issue, however, is that the previous owner 102 lives in another state, and typically, the county entity 108 in Florida may not be in communication with the appropriate tax revenue entities Georgia. In this example scenario, the particular states depicted are not intended to limit the scope of the disclosed technology, but rather to illustrate the common scenario.

FIG. 1B also depicts a common situation in which the previous owner 102 of the property 104 also owns a property 120 in Georgia. Information related to the additional property 120 in Georgia may be necessary in order to determine the proper tax consequences for the sale of the property 104 in Florida. For example, as depicted above in Table 2, the capital gains tax rate for a primary residence may be taxed at a different rate than a vacation home or secondary residence. In accordance with example embodiments of the disclosed technology, information from various sources may be utilized to determine whether or not a particular property is a primary or secondary residence. For example, in some states, a home can be considered a primary residence if the owner has lived in it four more than two of the previous five years. Such information may not be available or readily discernible from inspection of closing papers or a deed from a single transaction, and embodiments of the disclosed technology may utilize other sources of information to determine capital gains tax consequences for a particular or property. Certain example embodiments of the disclosed technology may further identify individuals having unreported capital gains from the sale of a property.

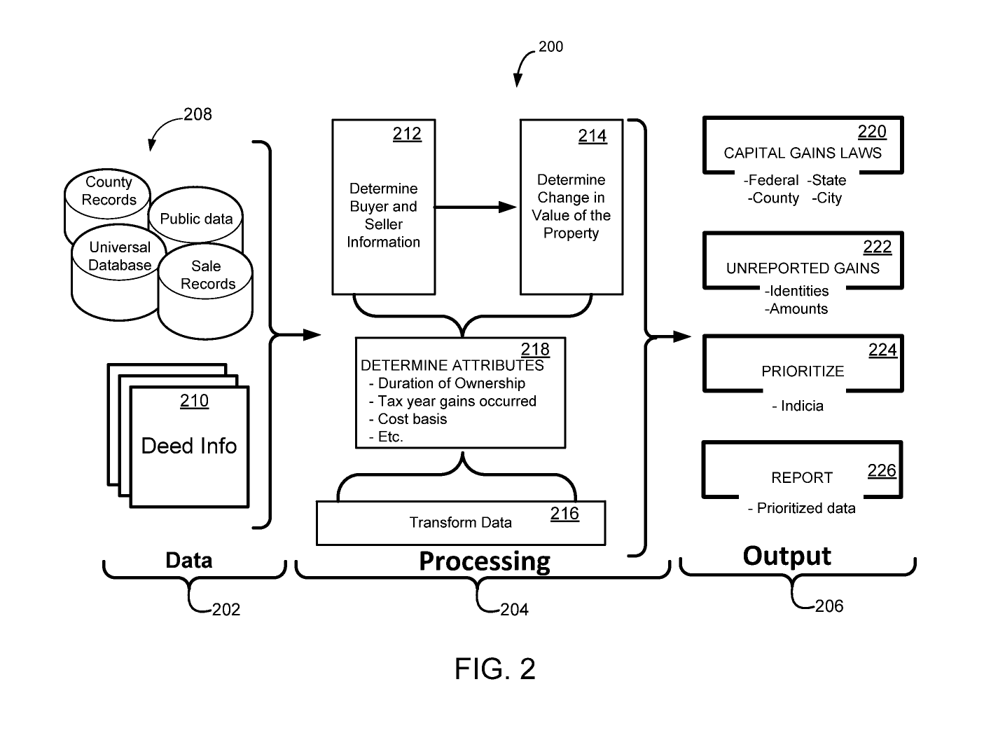

FIG. 2 illustrates an example property capital gains detection process 200 according to an example embodiment of the disclosed technology. At a high level, data 202 may be gathered, received, mined, etc., and processed 204 to produce various forms of output 206. According to an example embodiment, the data 202 may include information from various records 208 such as county records, public data records, database records, property sales records, and/or deed information 210. In an example embodiment be process 200 may be utilized to determine buyer and seller information 212 and to determine a change in the value of the property 214.

According to certain example embodiments of the disclosed technology, the process 200 may transform 216 the data 202 to eliminate duplicate records, correct typographical errors, link matching records, and/or prepare the data 202 in way that can be efficiently searched, categorized, and/or further processed. Example embodiments of the disclosed technology may utilize techniques described in Bayliss 1 and Bayliss II (incorporated by reference) to transform 216 the data 202 associated with an entity and/or a property.

In accordance with certain example embodiments of the disclosed technology, various attributes 218 may be determined based on one or more of: the buyer and seller information 212, the change in value of the property 214, the data 202 from the various sources, and/or the transformed data 216. In certain example embodiments, the attributes 218 may include information such as the duration of ownership, the tax year in which gains occurred, a cost basis for the property, whether or not the previous owners are deceased, the assessment of the property prior to the sale, the date (or dates) associated with a gain in the value of the property, the number of previous owners alive or deceased when the property was transferred, who sold the property, who is responsible for the capital gains, etc. In certain example embodiments, information from a sale of a property relating to the new owner may be stored in a database and retrieved for use upon determining a subsequent sale of the property.

According to certain example embodiments of the disclosed technology, the process 200 may additionally include providing output 206. The output 206 may take the form of a report, a webpage, and or human or machine-readable data. In certain example embodiments, the output 206 may be based on various laws 220. For example, the output 207 and may take into consideration laws at the federal, state, county, and/or local levels. In an example embodiment, the output 206 may include information related to unreported gains 222, such as the identities of the entities involved, potential amounts, potential taxable revenue, etc. In an example embodiment, the output may also include indicia or other rating information that may be utilized for prioritizing 224 the output information, for example, so that be various capital gains tax collecting entities may focus their limited resources and efforts on cases identified with the highest revenue potential. Such information may be presented in a report 226 with rankings in terms of confidence level, potential revenue, or other selectable factors.

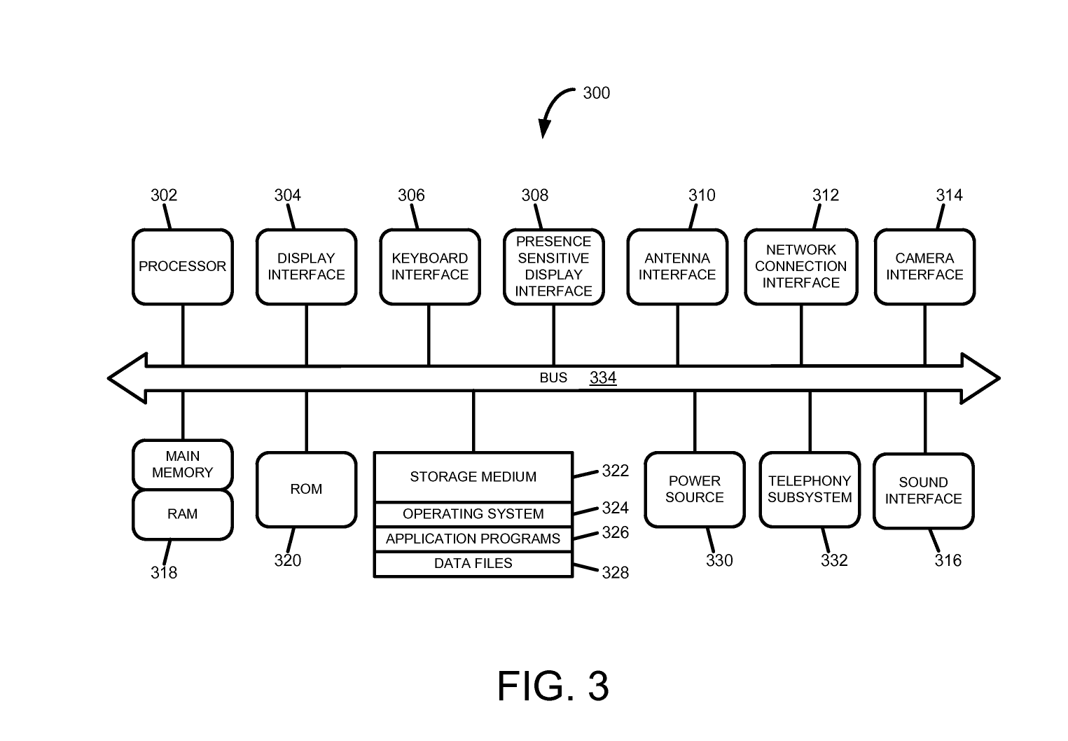

FIG. 3 depicts a block diagram of an illustrative property capital gains detection computing system 300 according to an example embodiment of the disclosed technology. Certain aspects of FIG. 2 may be implemented by the computing system 300 of FIG. 3. Various embodiments of the communication systems and methods herein may be embodied in non-transitory computer readable media for execution by a processor. It will be understood that the architecture illustrated in FIG. 3 is provided for example purposes only and does not limit the scope of the various embodiments of the communication systems and methods.

The computing system 300 of FIG. 3 may include one or more processors where computer instructions are processed. The computing system 300 may comprise the processor 302, or it may be combined with one or more additional components shown in FIG. 3. For example, in one example embodiment, the computing system 300 may be the processor 302. In yet other example embodiments, the computing system 300 may be a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing system 300 may include a computing device that may be a processor, controller, or a central processing unit (CPU). In yet other instances, a computing device may be a set of hardware components.

The computing system 300 may include a display interface 304 that acts as a communication interface and provides functions for rendering video, graphics, images, and texts on the display. In certain example implementations of the disclosed technology, the display interface 304 may be directly connected to a local display, such as a touch-screen display associated with the computing system 300. In another example implementation, the display interface 304 may be configured for providing data, images, and other information for an external/remote display that is not necessarily physically connected to the computing system 300. For example, a desktop monitor may be utilized for mirroring graphics and other information that is presented on the computing system 300. In certain example implementations, the display interface 304 may wirelessly communicate, for example, via a Wi-Fi channel or other available network connection interface 312 to the external/remote display.

In an example implementation, the network connection interface 312 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 304 may be operatively coupled to a local display, such as a touch-screen display associated with a mobile device. In another example, the display interface 304 may be configured to provide video, graphics, images, text, other information, or any combination thereof for an external/remote display that is not necessarily connected to the computing system 300. In one example, a desktop monitor may be utilized for miroring or extending graphical information that may be presented on a mobile device. In another example, the display interface 304 may wirelessly communicate, for example, via the network connection interface 312 such as a Wi-Fi transceiver to the external/remote display.

The computing system 300 may include a keyboard interface 306 that provides a communication interface to a keyboard. In one example implementation, the computing system 300 may include a presence-sensitive display interface 308 for connecting to a presence-sensitive display. According to certain example implementations of the disclosed technology, the presence-sensitive display interface 308 may provide a communication interface to various devices such as a pointing device, a touch screen, a depth camera, etc. which may or may not be associated with a display.

The computing system 300 may be configured to use an input device via one or more of input/output interfaces (for example, the keyboard interface 306, the display interface 304, the presence sensitive display interface 308, network connection interface 312, camera interface 314, sound interface 316, etc.) to allow a user to capture information into the computing system 300. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing system 300 or may be a separate device. For example, the input device may be an accelerometer, a magnetometer, a digital camera, a microphone, and an optical sensor.

Example implementations of the computing system 300 may include an antenna interface 310 that provides a communication interface to an antenna; a network connection interface 312 that provides a communication interface to a network. As mentioned above, the display interface 304 may be in communication with the network connection interface 312, for example, to provide information for display on a remote display that is not directly connected or attached to the system. In certain implementations, a camera interface 314 is provided that acts as a communication interface and provides functions for capturing digital images from a camera. In certain implementations, a sound interface 316 is provided as a communication interface for converting sound into electrical signals using a microphone and for converting electrical signals into sound using a speaker. According to example implementations, a random access memory (RAM) 318 is provided, where computer instructions and data may be stored in a volatile memory device for processing by the CPU 302.

According to an example implementation, the computing system 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing system 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example implementation, the computing system 300 includes a power source 330 that provides an appropriate alternating current (AC) or direct current (DC) to power components. According to an example implementation, the computing system 300 includes and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

According to one example implementation, the term computing device, as used herein, may be a CPU, or conceptualized as a CPU (for example, the CPU 302 of FIG. 3). In this example implementation, the computing device (CPU) may be coupled, connected, and/or in communication with one or more peripheral devices, such as display. In another example implementation, the term computing device, as used herein, may refer to a computing system 300, such as a smartphone or tablet computer. In this example embodiment, the computing device may output content to its local display and/or speaker(s). In another example implementation, the computing device may output content to an external display device (e.g., over Wi-Fi) such as a TV or an external computing system.

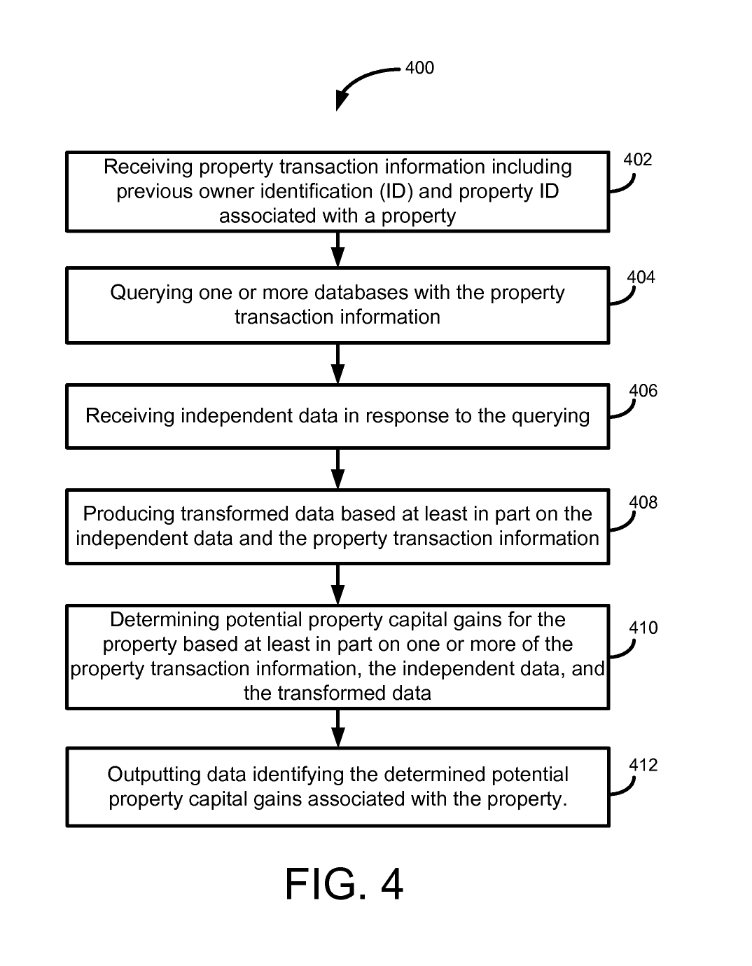

An example method 400 for detecting property capital gains will now be described with reference to the flowchart of FIG. 4. The method 400 starts in block 402, and according to an example embodiment of the disclosed technology includes receiving property transaction information comprising previous owner identification (ID) and property ID associated with a property. In block 404, the method 400 includes querying one or more databases with the property transaction information. In block 406, the method 400 includes receiving independent data in response to the querying. In block 408, the method 400 includes producing transformed data based at least in part on the independent data and the property transaction information. In block 410, the method 400 includes determining potential property capital gains for the property based at least in part on one or more of the property transaction information, the independent data, and the transformed data. In block 412, the method 400 includes outputting data identifying the determined potential property capital gains associated with the property.

In certain example embodiments, the property transaction information may include information identifying the seller, the property address, and the transaction date and/or year. In certain example embodiments, the property transaction information may include additional information, including, but not limited to the seller's social security number.

According to certain example implementations, the method and system may utilized one of the following property transaction information combinations as input to detect property capital gains: (1) Seller (or previous owner) Last Name, First Name or Initial, Street Address, City, State, and Year/Date of Transaction; (2) Seller Last Name, First Name or Initial, Street Address, Zip, and Year/Date of Transaction; (3) Seller Last Name, Social Security Number, Street Address, City, State, and Year/Date of Transaction; or (4) Seller Last Name, Social Security Number, Street Address, Zip, and Year/Date of Transaction. In accordance with an example implementation, the buyer's information and transaction sale price may also be received and associated with the transaction.

In certain example embodiment, producing the transformed data may include determining one or more attributes associated with the previous owner ID. The one or more attributes may include one or more of: a duration of ownership of the property, purchase date, sold date, basis value, a change in value of the property; in-state ownership, out-of-state ownership, tax year gains occurred, additional properties, residency, and a state in which a tax return was filed. In certain example implementations of the disclosed technology, producing the transformed data may include reconciling duplicate records and/or correcting typographical errors. According to an example implementation, the independent data may include information from one or more filed state income tax forms associated with the previous owner ID. In certain example implementations of the disclosed technology, the real-estate transaction information may additionally include the transaction date, transaction value, and new owner ID.

In an example implementation, determining potential property capital gains may include determining if there are long-term capital gains or short-term capital gains involved in a property sale. Short-term capital gains, for example, may be determined in response to a previous owner holding the property for less than 12 months and/or in response to a previous owner occupying the property for less than 2 of a previous 5 years.

In accordance with an example implementation, outputting data identifying the determined potential property capital gains associated with the property may include outputting one or more of: previous owner identification (ID), new owner ID, property ID, property address, change in value, date of change in value, duration of ownership, number of owners alive, number of owners deceased, number of owners alive or deceased when property was received or sold, assessment prior to sale, indicia of priority for investigation, tax year in which gain occurred, and state residency.

According to example embodiments, certain technical effects can be provided, such as creating certain systems and methods that detect property capital gains. Example embodiments of the disclosed technology can provide the further technical effects of providing systems and methods for identifying individuals with unreported property capital gains, thereby increasing the ability of governmental institutions to collect on owed taxes.

In example embodiments of the disclosed technology, the property capital gains detection computer system 300 may include any number of hardware and/or software applications that are executed to facilitate any of the operations. In example embodiments, one or more I/O interfaces may facilitate communication between the property capital gains detection computer system 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the property capital gains detection computer system 300. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the property capital gains detection computer system 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As desired, embodiments of the disclosed technology may include the property capital gains detection computer system 300 with more or less of the components illustrated in FIG. 3.

Certain embodiments of the disclosed technology are described above with reference to block and flow diagrams of systems and methods and/or computer program products according to example embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method for detecting property capital gains, the method comprising:
receiving property transaction information comprising previous owner identification (ID) and property ID associated with a property;
querying one or more databases with the property transaction information;
receiving independent data in response to the querying;
producing transformed data based at least in part on the independent data and the property transaction information;
determining potential property capital gains for the property based at least in part on one or more of the property transaction information, the independent data, and the transformed data; and
outputting data identifying the determined potential property capital gains associated with the property.

2. The method of claim 1, wherein producing the transformed data comprises determining one or more attributes associated with the previous owner ID, wherein the one or more attributes comprise one or more of: a duration of ownership of the property, purchase date, sold date, basis value, a change in value of the property; in-state ownership, out-of-state ownership, tax year gains occurred, additional properties, residency, and a state in which a tax return was filed.

3. The method of claim 1, wherein producing the transformed data comprises one or more of reconciling duplicate records and correcting typographical errors.

4. The method of claim 1, wherein the independent data comprises information from one or more filed state income tax forms associated with the previous owner ID.

5. The method of claim 1, wherein determining potential property capital gains comprises determining long-term capital gains or short-term capital gains, wherein short-term capital gains are determined in response to a previous owner holding the property for less than 12 months or in response to a previous owner occupying the property for less than 2 of a previous 5 years.

6. The method of claim 1, wherein the real-estate transaction information further comprises transaction date, transaction value, and new owner ID.

7. The method of claim 1, wherein outputting data identifying the determined potential property capital gains associated with the property comprises outputting one or more of: previous owner identification (ID), new owner ID, property ID, property address, change in value, date of change in value, duration of ownership, number of owners alive, number of owners deceased, number of owners alive or deceased when property was received or sold, assessment prior to sale, indicia of priority for investigation, tax year in which gain occurred, and state residency.

8. A system comprising:
at least one memory for storing data and computer-executable instructions; and at least one processor configured to access the at least one memory and further configured to execute the computer-executable instructions to:
receive property transaction information comprising previous owner identification (ID) and property ID associated with a property;
query one or more databases with the property transaction information;
receive independent data in response to the querying;
produce transformed data based at least in part on the independent data and the property transaction information;
determine potential property capital gains for the property based at least in part on one or more of the property transaction information, the independent data, and the transformed data; and
output data identifying the determined potential property capital gains associated with the property.

9. The system of claim 8, wherein the transformed data comprises one or more attributes associated with the previous owner ID, wherein the one or more attributes comprise one or more of: a duration of ownership of the property, purchase date, sold date, basis value, a change in value of the property; in-state ownership, out-of-state ownership, tax year gains occurred, additional properties, residency, and a state in which a tax return was filed.

10. The system of claim 8, wherein the transformed data comprises one or more of reconciled duplicate records and corrected typographical errors.

11. The system of claim 8, wherein the independent data comprises information from one or more filed state income tax forms associated with the previous owner ID

12. The system of claim 8, wherein potential property capital gains comprises long-term capital gains or short-term capital gains, wherein short-term capital gains are determined in response to a previous owner holding the property for less than 12 months or in response to a previous owner occupying the property for less than 2 of a previous 5 years.

13. The system of claim 8, wherein the real-estate transaction information further comprises transaction date, transaction value, and new owner ID

14. The system of claim 8, wherein the data identifying the determined potential property capital gains associated with the property comprises one or more of: previous owner identification (ID), new owner ID, property ID, property address, change in value, date of change in value, duration of ownership, number of owners alive, number of owners deceased, number of owners alive or deceased when property was received or sold, assessment prior to sale, indicia of priority for investigation, tax year in which gain occurred, and state residency.

15. One or more non-transitory computer readable media comprising computer-executable instructions that, when executed by one or more processors, cause the one or more processors to perform a method comprising:
receiving property transaction information comprising previous owner identification (ID) and property ID associated with a property;
querying one or more databases with the property transaction information;
receiving independent data in response to the querying;
producing transformed data based at least in part on the independent data and the property transaction information;
determining potential property capital gains for the property based at least in part on one or more of the property transaction information, the independent data, and the transformed data; and
outputting data identifying the determined potential property capital gains associated with the property.

16. The computer readable media of claim 15, wherein producing the transformed data comprises determining one or more attributes associated with the previous owner ID, wherein the one or more attributes comprise one or more of: a duration of ownership of the property, purchase date, sold date, basis value, a change in value of the property; in-state ownership, out-of-state ownership, tax year gains occurred, additional properties, residency, and a state in which a tax return was filed.

17. The computer readable media of claim 15, wherein producing the transformed data comprises one or more of reconciling duplicate records and correcting typographical errors.

18. The computer readable media of claim 15, wherein the independent data comprises information from one or more filed state income tax forms associated with the previous owner ID.

19. The computer readable media of claim 15, wherein determining potential property capital gains comprises determining long-term capital gains or short-term capital gains, wherein short-term capital gains are determined in response to a previous owner holding the property for less than 12 months or in response to a previous owner occupying the property for less than 2 of a previous 5 years.

20. The computer readable media of claim 15, wherein outputting data identifying the determined potential property capital gains associated with the property comprises outputting one or more of: previous owner identification (ID), new owner ID, property ID, property address, change in value, date of change in value, duration of ownership, number of owners alive, number of owners deceased, number of owners alive or deceased when property was received or sold, assessment prior to sale, indicia of priority for investigation, tax year in which gain occurred, and state residency.
